(19) United States
(12) Patent Application Publication
(10) Pub. No.: US 2017/0026460 A1
(43) Pub. Date: Jan. 26, 2017

(54) USER DEFINED GEOGRAPHICAL ZONES FOR CHAT PLATFORMS

(71) Applicant: ChatZone, Inc., Columbus, OH (US)

(72) Inventor: Ravi Harikrishan Patel, Columbus, OH (US)

(21) Appl. No.: 15/216,263

(22) Filed: Jul. 21, 2016

Related U.S. Application Data
(60) Provisional application No. 62/196,680, filed on Jul. 24, 2015.

(51) Int. Cl. H04L 29/08; H04L 29/06; H04L 12/58

(52) U.S. Cl. CPC H04L 67/10; H04L 51/04; H04L 51/32; H04L 67/306; H04L 67/22; H04L 51/24; H04L 65/4076

(57) ABSTRACT

The innovation disclosed and claimed herein, in one aspect thereof, comprises systems and methods of creating and managing social networking chat platforms according to user defined geographical zones. The system and method facilitates users to create user defined geographical zones on a map. The geographical zones correlate to physical areas in the world. Chat interfaces are created and associated with the geographical zones. Chat privileges can be arbitrated according to user location, user status, or the like.

### CROSS-REFERENCE TO RELATED APPLICATIONS

This application claims the benefit of pending U.S. Provisional Patent Application Ser. No. 62/196,680 entitled “USER-DEFINED GEOGRAPHICAL FENCING FOR INTERACTION ZONES” filed on Jul. 24, 2015. The entirety of the above-noted application is incorporated by reference herein.

### BACKGROUND

Mobile applications (e.g., “apps”) allow people to interact with each other in increasingly unique methods. However, typically, users of applications must know one another's phone numbers or otherwise be connected through a social network. Some applications enable a user to search for other users of the same application within a radius from the user's device. However, these conventional applications are limited and only offer black box functionality. For instance, the user may only designate a maximum distance within which to search for available users and the system searches radially from the location of the user.

The conventional black box systems deny users flexibility and therefore functionality. Most of these systems only offer a radius on a per mile scale. For example, a user employing such a system will receive results from every user within a mile. This can be problematic for users who desire more granular results. Further, a user cannot easily define the area covered in the search. For example, if a user is near a body of water, it would be undesirable to search in a radius from the user's device where there may not be any users in the water. Instead, a user would want to search the area covered by land. For example, a user may want to search a geographical area of interest such as a baseball park or office building.

### BRIEF DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of creating and sharing geographical zones or fences. In examples, these geographical zones can be used for social interaction and therefore coined “chat zones.” The chat zones are user defined and created, therefore unique to the user and modifiable. The geographical chat zones are shared with other users in real time or near real time.

In one example aspect of the innovation, a system that facilitates geographical chat zones is provided. The system includes a fencing component that creates a geographical zone based on an input of the user. The system includes a chat component that creates a chat interface associated with the geographical zone for users located within the geographical zone to send chat messages to the chat interface.

In another example embodiment of the innovation, a method is provided. The method includes receiving an input of a user. The method also includes generating a geographical zone based on an input of the user. The method further includes creating a chat interface associated with the geographical zone for users located within the geographical zone to send chat messages to the chat interface.

In yet another example embodiment, a non-transitory computer readable medium having instructions to direct one or more processors is provided. The instructions include generating a map around a location of a user; and receiving an input of the user defining boundaries of a geographical zone by the user interacting with the map. The instructions include generating a geographical zone based on the input of the user. The instructions also include creating a chat interface associated with the geographical zone for users located within the geographical zone to send chat messages to the chat interface.

In aspects, the subject innovation provides substantial benefits in terms of social networking of people in the same geolocation. One advantage resides in increased granularity in finding users with whom to connect. Another advantage resides in automatic sharing of user created geographical chat zones.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates an example system for creating and using geographical chat zones.

FIG. 2 illustrates an example component diagram of a fencing component.

FIG. 3 illustrates an example component diagram of a chat component.

FIG. 4 illustrates an example method for creating geographical chat zones.

FIG. 5 illustrates an example screenshot of geographical zones on a map.

FIG. 6 illustrates an example screenshot of location points on a map.

FIG. 7 illustrates an example screenshot of location points on a map.

FIG. 8 illustrates an example screenshot of location points on a map.

FIG. 9 illustrates an example screenshot of location points on a map.

FIG. 10 illustrates a computer-readable medium or computer-readable device comprising processor-executable instructions configured to embody one or more of the provisions set forth herein, according to some embodiments.

FIG. 11 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the specification and/or claimed subject matter.

While certain ways of displaying information to users are shown and described with respect to certain figures as screenshots, those skilled in the relevant art will recognize that various other alternatives can be employed. The terms “screen,” “web page,” “screenshot,” and “page” are generally used interchangeably herein. The pages or screens are stored and/or transmitted as display descriptions, as graphical user interfaces, or by other methods of depicting information on a screen (whether personal computer, PDA, mobile telephone, tablet, watch, or other suitable device, for example) where the layout and information or content to be displayed on the page is stored in memory, database, or another storage facility.

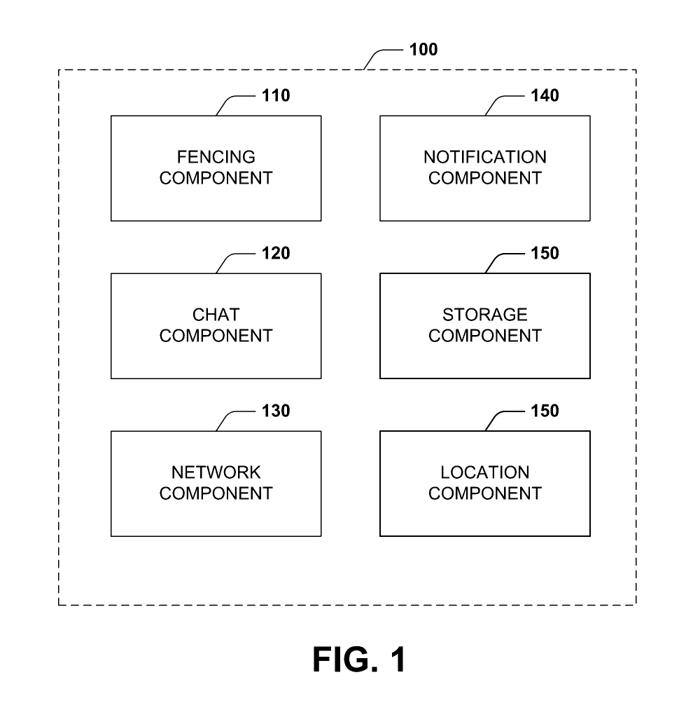

With reference to FIG. 1, a system 100 for creating and managing chat interfaces according to user created geographical zones is depicted. The system 100 can operate with one or more user devices. The user devices can install and run software, such as a mobile application, to operate and interface with the system 100. In this embodiment, the system 100 includes a fencing component 110. The fencing component 110 (or Fence Definition Component) enables a user to define and generate a geographical zone on a map using a geofencing algorithm. The fencing component 110 creates boundaries from an input of the user. For example, the user can define a geofence via a free format drawing or dropped location points on a map. The geofencing algorithm connects the dropped location points on the map in a logical fashion such as to create an enclosed geographical zone. In this aspect, the fencing component 110 can employ logic that avoids either known or user-defined obstructions within a zone (e.g., bodies of water). The geographical zones on the map correlate to real life areas in the world within which interactions with users and/or user devices may be performed. The fencing component 110 can store (and retrieve) previously created geographical zones. The previously created geographical zones can be user selectable. The fencing component 110 is described in further detail below.

Following is a discussion of an aspect of the innovation that employs some unique features, functions and benefits of the innovation in a social networking or ‘chat platform’ scenario. While these aspects are described and defined in detail, it is to be understood and appreciated that ‘chat’ scenarios are not meant to limit the spirit and/or scope of the innovation described herein. Rather, this is but one embodiment that utilizes features of the innovation. For example, in other examples, a user (or other entity (e.g., corporation, advertiser, etc.) may employ the innovation to define a geographical zone or geofence to search for services, places of interest, target advertise or the like. These and other aspects are to be appreciated and therefore included within the scope of the innovation and claims appended hereto.

Continuing with the aforementioned example, the system 100 includes a chat component 120. The chat component 120 interacts with the fencing component 110 to receive the defined geographical zone, either a newly created zone or a selected saved geographical zone. The chat component 120 receives the geographical zone from the fencing component 110. The chat component 120 monitors or searches for users within the geographical zone. The chat component 120 creates a chat interface associated with each geographical zone. In aspects, the chat component 120 creates a chat interface having qualifying parameters and privileges for users. The qualifying parameters can limit social interaction or send/receipt of chats to only users within the created geographical zone. The ‘chat platform’ may be accessible by any user located within the geographical zone. In one embodiment, users outside the zone may be allowed read access of the chat interface for the geographical zone. However, the outside user may be blocked from posting to the chat interface. In yet other aspects, a user outside the boundary of a zone may request permission to interact within a zone. For example, the zone definer may grant or deny access as/if desired.

When a user is within the boundaries of the zone and employs the system, the chat component 120 registers the user to the chat interface. In one embodiment, the user can be within multiple (e.g., overlapping) zones. The chat component 120 registers the user for each chat interface. For example, when two or more geographical zones overlap, the chat component 120 registers a user whose location is in the overlapping region for each chat interface associated with the respective geographical zone. In another embodiment, the user can select preferences for geographical zones to prioritize or disregard overlapping geographical zones. In another embodiment, the user can select another user within the zone for a user-to-user private chat.

The chat component 120 can utilize user profiles for registering (or otherwise denying access to) users in the chat interfaces. For example, the chat component 120 can register the user with a randomized avatar and username. In one embodiment, the user may select or create a unique chat name and/or avatar. The chat component 120 can display information to the user about the chat interface, such as number of users, locations of users, demographics of users, etc. In one embodiment, a user may be granted extra privileges to enable messaging a chat interface when outside of the geographical zone associated with the chat interface. In a specific embodiment, the user receives the extra privileges is a paying user and/or advertiser.

In one embodiment, the fencing component 110 can display the boundaries of the geographical zone in which the user is located concurrently with the chat component 120 displaying the chat interface, so the user can stay within the boundaries. The chat component 120 is described in further detail below.

In the described embodiment, the system 100 includes a network component 130. The network component 130 can access servers, cloud-based devices/entities, other components, other user devices, and/or the like. The network component 130 can interface over mobile data networks, wired local area networks (LANs), wireless LANs, Bluetooth, Peer-to-Peer networks and/or the like. As will be appreciated, the network component 130 can share geographical zones and associated chat interfaces with other users or user devices connected to the system 100. The chat component 120 sends (and receives) chats in the chat interface over the network component 130 to other users accessing the chat interface.

Further, the system 100 includes a notification component 140. The notification component 140 generates notifications to users of the system 100, for instance, regarding operation of the system, entry and exit of a geographical zone(s), and/or the chat interfaces. For example, the notification component 140 can generate a notification when a user is entering (or about to enter) a geographical zone regarding the availability of an associated chat interface. In one embodiment, the notification component 140 can generate a notification when a user is about to leave a geographical zone. In aspects, the notification component 140 can generate push notifications when chats are posted to chat interfaces followed by a user. The notifications can be sent over the network component 130 and/or over transmission servers to user devices. Further, the notification component 140 can be employed to suggest a defined zone as well as to suggest zone definition. For instance, the notification component 140 can alert a user of an obstruction (e.g., water) within a defined zone or the like. Moreover, the notification component 130 can alert a user of entry or proximity of a desired zone, person, previously defined zone or the like. These notifications can employ most any delivery method including, without limitation, audible, visible, vibratory, haptic, SMS (text) or the like.

The system 100 includes a storage component 150. The storage component 150 can include non-transitory computer readable storage media. The storage component 150 can facilitate retention of defined zones and/or previously created geographical zones, chat interface histories, user profiles, application data, and/or the like. In one embodiment, the storage component 150 can store the boundaries and area enclosed by the geographical zone as global positioning system (GPS) coordinate data. In one embodiment, stored geographical zones may be deleted if no chat interface activity is detected for a predetermined period, e.g., 30 days. In one embodiment, the storage component 150 can be local to the system 100. In another embodiment, the storage component 150 is remote (e.g., cloud based) to the system 100, accessible via the network component 130.

The system 100 includes a location component 160. The location component 160 determines and monitors the position or location of a user, multiple users, and/or user device(s). The location component 160 can determine the position using GPS data, Wi-Fi data, cell tower triangulation, and/or the like. In one embodiment, the location component 160 can update the system 100 with locations of users in real time or near real-time. The fencing component 110 uses the location of a user to generate maps centered around the location. In one embodiment, the fencing component 110 can only allow a geographical zone to be created that includes the current location of the user. The chat component 120 can activate/deactivate user privileges according to the location of the user from the location component 160.

While embodiments contemplate definition of a geofence in scenarios where a user is within the defined zone, it is to be understood and appreciated that a user can employ the innovation to define a zone in scenarios where a user is not within the defined zone. For example, a user may be interested to locate people, places, services, etc. within a defined zone of interest for a later visit. Here, the innovation enables definition of the geographical zone, e.g., free-format drawing or pin dropping to define the boundary.

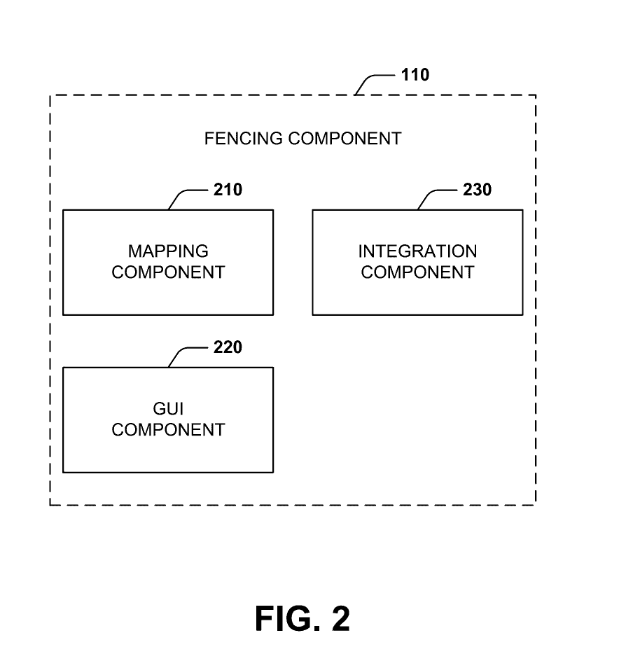

With reference to FIG. 2, an example component diagram of a fencing component 110 is depicted. The fencing component 110 includes a mapping component 210. The mapping component 210 can generate maps and images, e.g., to be presented to the user. The mapping component 210 can receive user inputs via a graphical user interface (GUI) component 220. The inputs can dictate boundaries of the zone. In one embodiment, the user can input, or “drop,” location points onto the map. The GUI component 220 receives user inputs where the user describes the geographical zone created by the boundaries. The GUI component 220 provides user interaction with the map generated by the mapping component 210. For example, the map is presented via a display on the user device. The GUI component 220 facilitates the user to interact with the map in real (or near-real) time such as zoom in/out, rotate, and the like. The map may display the location of roads, buildings, monuments, addresses, bodies of water, other map features, and/or the like.

In one embodiment, the mapping component 210 can receive the user inputted location points and create boundaries from the location points (e.g., ‘pins’). In aspects, the user drops at least three or more location points via the GUI component 220. The mapping component 210 employs logic to connect the points in a manner as to form a closed boundary around a newly created geographical zone. In another embodiment, the user drops four location points to dictate the corners of the zone. In another embodiment, the user can drop unlimited location points to define a geographical zone. In yet another embodiment, the user can draw, e.g. drag a finger on a user device display screen, a boundary on the map such that the mapping component 210 creates a closed boundary around the zone in the shape of the drawing. Alternative embodiments can suggest a boundary (or expansion/retraction of a boundary) based upon a variety of factors including but, not limited to, geography, users within a defined zone, users near a defined zone, context, population, etc. In one embodiment, the mapping component 210 can auto-label the geographical zones, e.g. names, to differentiate the zones from each other. User-defined labels are also supported by the innovation. The mapping component 210 may regulate some actions of a user. For example, a user may be limited to a maximum number of zones created in a time period, e.g., one day.

The fencing component 110 includes an integration component 230. The integration component 230 can operate with the mapping component 210 to use maps and/or data from a third party system. The integration component 230 can receive map data from the third party system via an application programming interface (API) call and response, download, and/or the like. The map data can includes addresses, GPS coordinates of buildings, landmarks, waterways, natural formations, rural/urban area distinctions and the like. The mapping component 210 can receive the map or map data via the integration component 230. The mapping component 210 can overlay geographical zones, locations points, GPS coordinate data, and/or other data over the received maps and/or map data.

In one embodiment, the mapping component 210 can detect that the geographical zone includes a multi-level building. In this embodiment, the mapping component 210 can query the user to include elevation data to further define the geographical zone. For example, a user creates a geographical zone including a high-rise apartment building. The user can specify that the geographical zone is created for the specific floor or range of floors in the building using the elevation data. The mapping component 210 can determine that the geographical zone includes the building and query the user to include elevation data for the geographical zone.

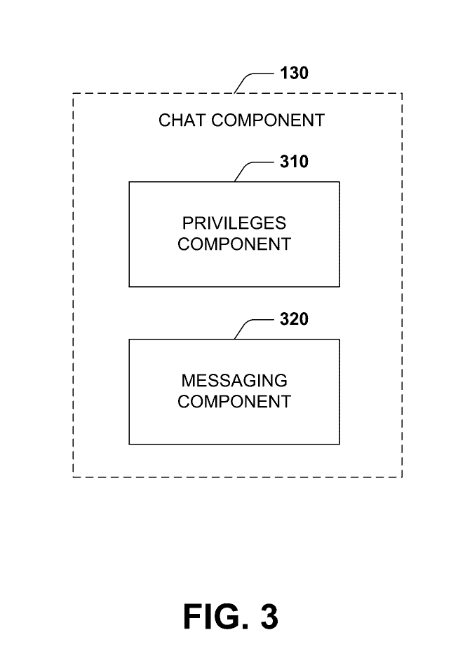

With reference to FIG. 3, an example component diagram of the chat component 130 is depicted. The chat component 130 includes a privileges component 310. The privileges component 310 can monitor the locations of multiple users. The privileges component 310 can allow (or deny) a subset of the multiple users that are located within the geographical zone to send chat messages to the associated chat interface of the geographical zone. The privileges component 310 can prevent a subset of the multiple users that are located outside the geographical zone from sending chat messages to the associated chat interface.

In one embodiment, the privileges component 310 can regulate a chat user's behavior. As another example, users can receive flags, e.g. warnings, from other users for inappropriate chats in the chat interfaces. A user may be suspended for a certain time period if the user reaches a maximum number of flags from other users.

The chat component 130 includes a messaging component 320. The messaging component 320 can receive messages from a user in the chat interface. The messaging component 320 can send (and facilitate reception of) the messages to each user in the chat interface. Messages can be text chat, emojis, media messages, or the like such as, but not limited to, a video recording, video livestreaming, audio recording, audio livestreaming, photograph, moving GIFs, and/or the like. Messages including text may be user or system-limited to a predetermined amount of characters. Similarly, multimedia messages can be user- or system-limited to a predetermined file size.

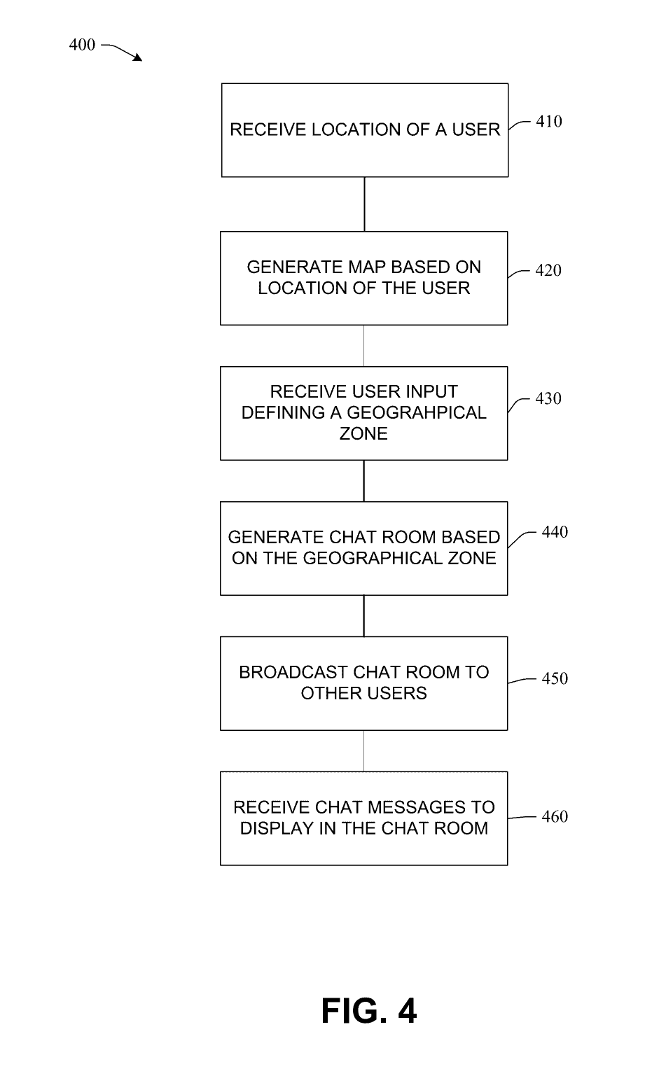

With reference to FIG. 4, an example method 400 is depicted for generating geographical zones and associated chat interfaces. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. It is also appreciated that the method 400 is described in conjunction with a specific example is for explanation purposes.

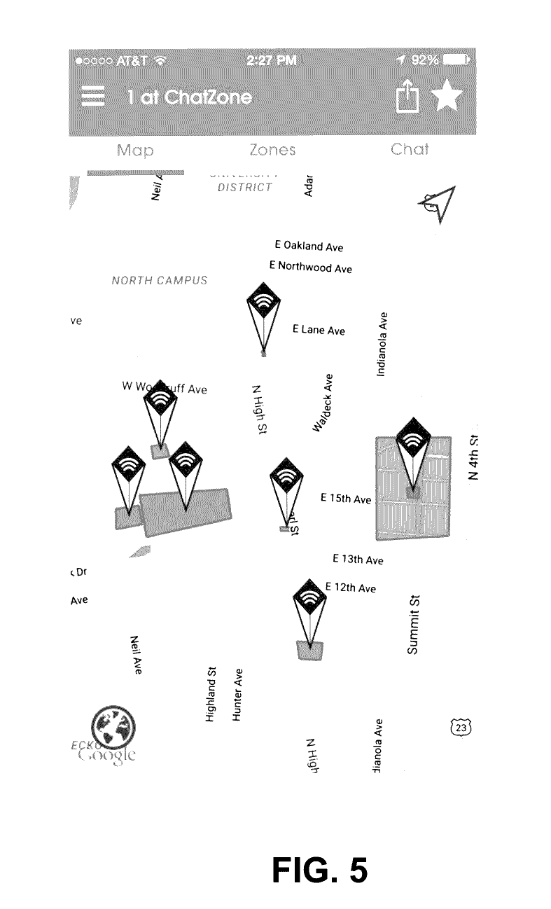

In aspects, the method 400 can begin at 410 by receiving a location of a user and/or user device. In this specific example, the user opens a mobile application on their user device. The mobile application retrieves GPS coordinates or other location data. At 420, a map is generated based on the location of the user. In the example, the map can be generated showing the surrounding geographical area of the user's location. The map may include buildings, roads, landmarks, waterways, and/or the like. The map may also show previously created geographical zones to the user, to which the user may navigate and interact with the associated chat interface, or view the associated chat interface remotely. With reference to FIG. 5, a generated map is depicted showing previously created geographical zones. A user may select a previously created geographical zone and view the associated chat interface. It is to be appreciated that, if depicted, previously created zones can be specific to the instant user or other users of whom share their predefined zones.

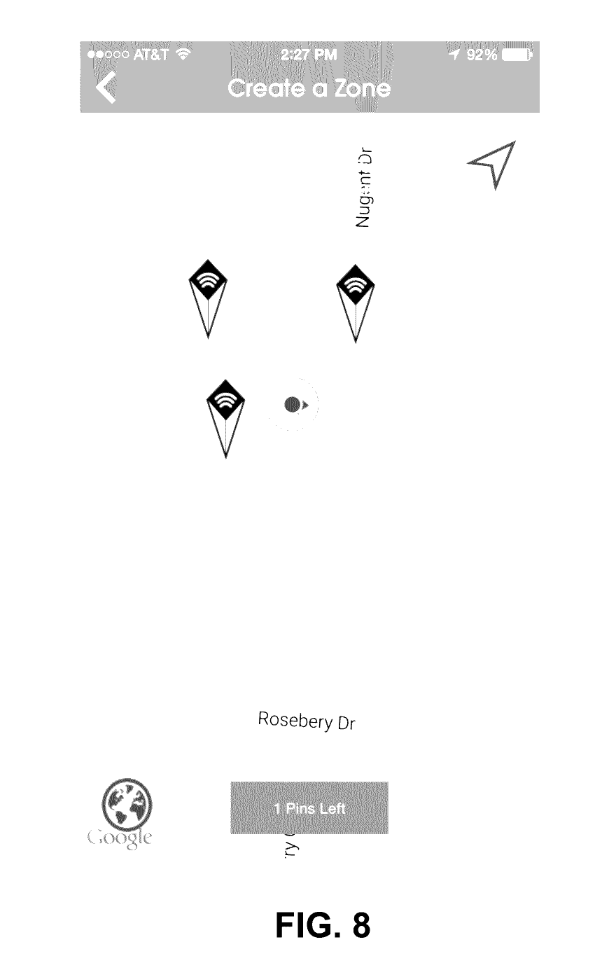

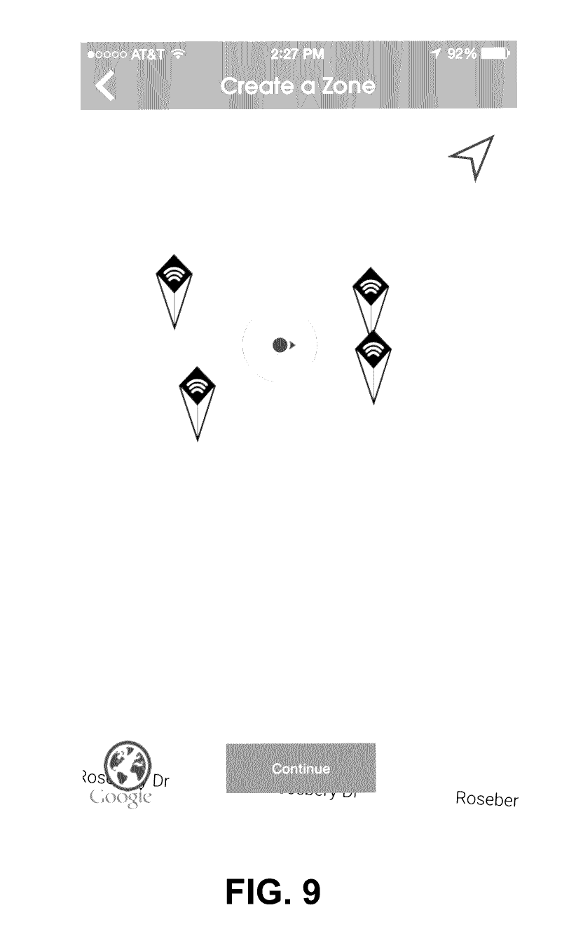

At 430, a user input is received to define a new geographical zone. In the example, the user can manipulate the map to create a geographical zone via the user device, e.g. mobile phone. First, the user accesses a menu option of the application. Of the menu options, the user selects “Create a Zone.” The user can select the type of zone to create. The user can drop location points or ‘pins’ to define an area from which to create a geographical zone. In a specific embodiment, with reference to FIGS. 6-9, 4 location points are individually dropped onto the map to define the corners of a newly created geographical zone. Once the location points are dropped, the user can edit the location of the points to refine the precise boundaries the user desires. The user confirms the location points, and the boundaries of the zone to be used are created. In an alternate embodiment, the user can free from draw a geographical zone on the map. In another alternate embodiment, the user can draw a non-linear line having a start point and an end point. The start point and end point can be connected to create a closed geographical zone. As an option, the user may input a title or name to save the zone for later use.

At 440, a chat interface associated with the geographical zone is created. The chat interface can be created with privileges dependent to the location of users using the mobile application. In the example, users that are located inside the geographical zone are able to send messages to the chat interface, while users located outside may only be granted reading privileges. At 450, chat messages are received in the chat interface from users within the geographical zone. The chat messages posted to the chat interface can be read by users accessing the chat interface through the mobile application. In one embodiment, notifications can be sent to each user of the chat interface when a new chat message is posted.

As identified above, FIGS. 5-9 are example screenshots of an example GUI in accordance with an aspect of the innovation. It is to be understood and appreciated that these screenshots are merely examples of the innovation and are not intended to limit the spirit and/or scope in any manner. In particular, FIG. 5 illustrates various preset zones or geofences in accordance with aspects of the innovation. Here, a user is able to select a particular zone as/of desired.

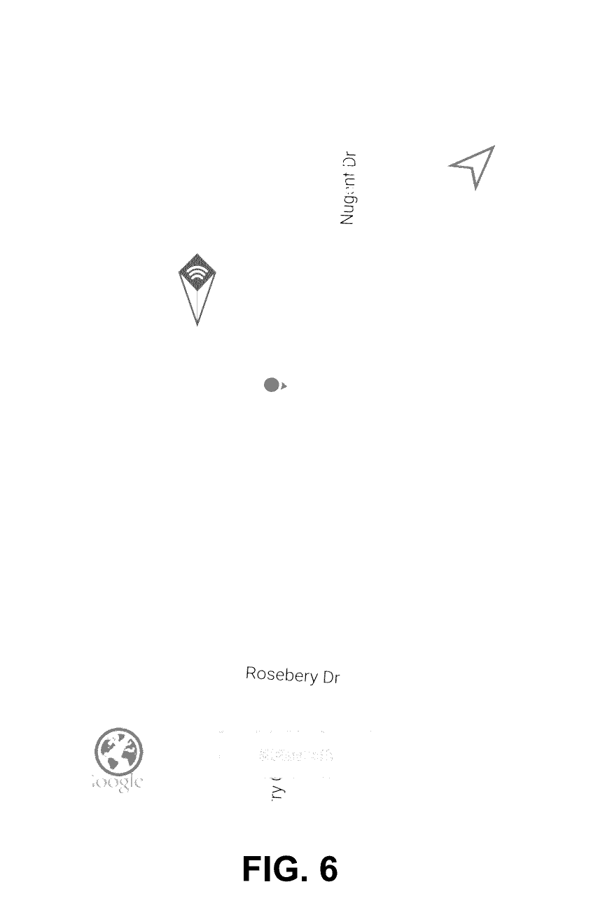

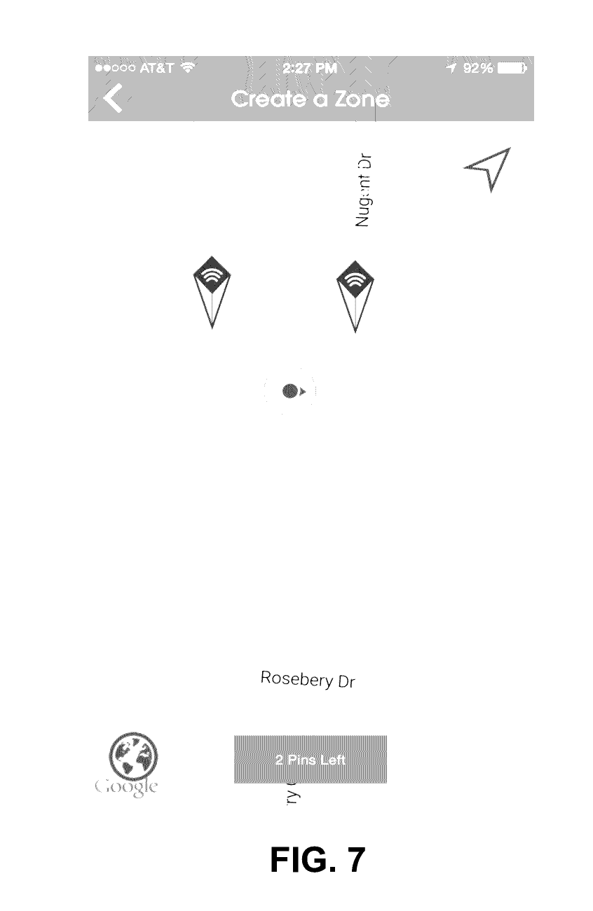

FIGS. 6-9 illustrate a chronology of defining a zone by dropping pins onto a map. For instance, FIG. 6 illustrates a first pin dropped as indicated thereon. The circle in the middle of the image is illustrative of a user or device's current location. Also, as shown, the GUI indicates that there are 3 pins left or remaining to define a zone. The continued sequence is illustrated by FIGS. 7, 8 and 9 wherein pins 2, 3 and 4 are dropped respectively thereby defining a desired zone.

As stated above, while this embodiment employs 4 pins to define a zone, other aspects can be employed that utilize more or fewer pins without departing from the spirit and/or scope of the innovation or claims appended hereto.

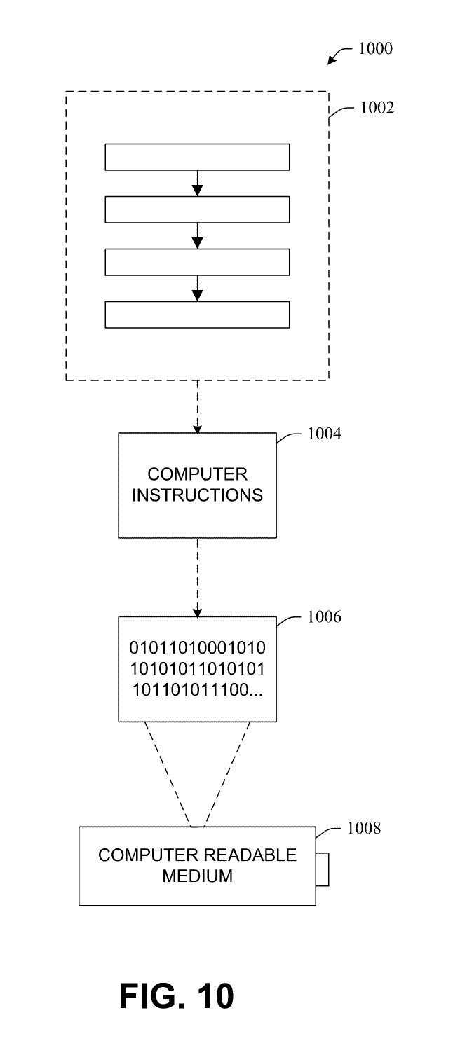

Still another embodiment can involve a computer-readable medium comprising processor-executable instructions configured to implement one or more embodiments of the techniques presented herein. An embodiment of a computer-readable medium or a computer-readable device that is devised in these ways is illustrated in FIG. 10, wherein an implementation 1000 comprises a computer-readable medium 1008, such as a CD-R, DVD-R, flash drive, a platter of a hard disk drive, etc., on which is encoded computer-readable data 1006. This computer-readable data 1006, such as binary data comprising a plurality of zero's and one's as shown in 1006, in turn comprises a set of computer instructions 1004 configured to operate according to one or more of the principles set forth herein. In one such embodiment 1000, the processor-executable computer instructions 1004 is configured to perform a method 1002, such as at least a portion of one or more of the methods described in connection with embodiments disclosed herein. In another embodiment, the processor-executable instructions 1004 are configured to implement a system, such as at least a portion of one or more of the systems described in connection with embodiments disclosed herein. Many such computer-readable media can be devised by those of ordinary skill in the art that are configured to operate in accordance with the techniques presented herein.

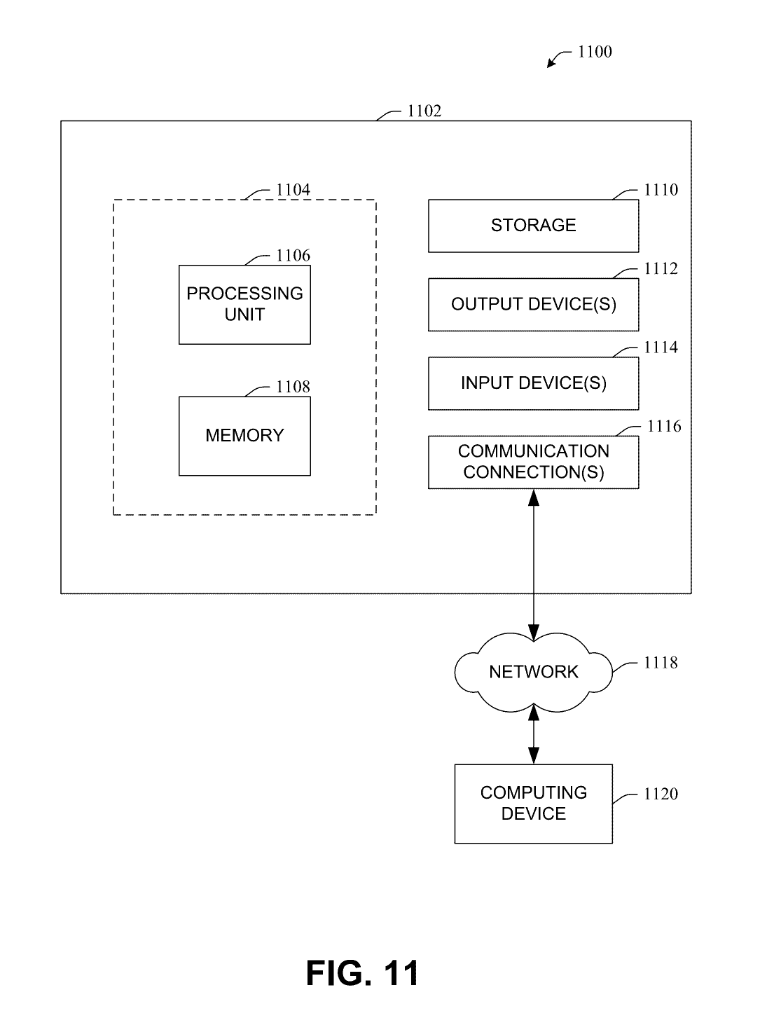

With reference to FIG. 11 and the following discussion provide a description of a suitable computing environment in which embodiments of one or more of the provisions set forth herein can be implemented. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 11 illustrates a system 1100 comprising a computing device 1102 configured to implement one or more embodiments provided herein. In one configuration, computing device 1102 can include at least one processing unit 1106 and memory 1108. Depending on the exact configuration and type of computing device, memory 1108 may be volatile, such as RAM, non-volatile, such as ROM, flash memory, etc., or some combination of the two. This configuration is illustrated in FIG. 11 by dashed line 1104.

In these or other embodiments, device 1102 can include additional features or functionality. For example, device 1102 can also include additional storage such as removable storage or non-removable storage, including, but not limited to, magnetic storage, optical storage, and the like. Such additional storage is illustrated in FIG. 11 by storage 1110. In some embodiments, computer readable instructions to implement one or more embodiments provided herein are in storage 1110. Storage 1110 can also store other computer readable instructions to implement an operating system, an application program, and the like. Computer readable instructions can be accessed in memory 1108 for execution by processing unit 1106, for example.

The term “computer readable media” as used herein includes computer storage media. Computer storage media includes volatile and nonvolatile, removable and non-removable media implemented in any method or technology for storage of information such as computer readable instructions or other data. Memory 1108 and storage 1110 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1102. Any such computer storage media can be part of device 1102.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 1102 can include one or more input devices 1114 such as keyboard, mouse, pen, voice input device, touch input device, infrared cameras, video input devices, or any other input device. One or more output devices 1112 such as one or more displays, speakers, printers, or any other output device can also be included in device 1102. The one or more input devices 1114 and/or one or more output devices 1112 can be connected to device 1102 via a wired connection, wireless connection, or any combination thereof. In some embodiments, one or more input devices or output devices from another computing device can be used as input device(s) 1114 or output device(s) 1112 for computing device 1102. Device 1102 can also include one or more communication connections 1116 that can facilitate communications with one or more other devices 1120 by means of a communications network 1118, which can be wired, wireless, or any combination thereof, and can include ad hoc networks, intranets, the Internet, or substantially any other communications network that can allow device 1102 to communicate with at least one other computing device 1120.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates geographical chat zones, comprising:
a fencing component that creates a geographical zone based at least in part upon on an input of the user, wherein the input is defined via a graphical user interface; and
a chat component that creates a chat interface associated with the geographical zone for users located within the geographical zone to send or receive messages within the chat interface.

2. The system of claim 1, comprising:
a mapping component that generates a map based upon a location of the user.

3. The system of claim 2, comprising:
a graphical user interface component that facilitates the input from a user wherein the user creates the geographical zone via the graphical user interface component.

4. The system of claim 3, wherein the input from the user is defined by dropping three or more location ‘pins’ such that the fencing component creates zone boundaries by connecting the three or more location pins.

5. The system of claim 3, wherein the input from the user is a closed loop input drawn on the map generated by the mapping component.

6. The system of claim 1, comprising:
a network component that shares the geographical zone with other users of the system.

7. The system of claim 1, wherein the chat component monitors the location of the users to continuously update the users within the geographical zone, wherein the chat component prevents users outside the geographical zone from sending messages to the chat interface.

8. The system of claim 1, comprising a notification component that generates and sends an alert to users entering, leaving, or interacting with the geographical zone.

9. The system of claim 1, comprising:
a storage component that saves the geographical zone, wherein the geographical zone is stored using global positioning satellite coordinates of the area within the boundaries of the geographical zone.

10. A method, comprising:
receiving an input of a user, wherein the input defines a graphical zone;
generating the geographical zone based on the input of the user; and
creating a chat interface associated with the geographical zone for users located within the geographical zone to send or receive messages to the chat interface.

11. The method of claim 10, comprising:
generating a map centered around a location of the user.

12. The method of claim 11, wherein the received input from the user defines boundaries of the geographical zone by the user interacting with the map.

13. The method of claim 12, comprising:
wherein the input from the user is three or more location pins dropped onto the map such that geographical zone boundaries are created by connecting the three or more location points.

14. The method of claim 12, comprising:
drawing a closed geographical zone boundary on the map, wherein the geographical zone boundary encompasses the location of the user.

15. The method of claim 10, comprising:
sharing the geographical zone with one or more other users in near real time.

16. The method of claim 10, comprising:
monitoring the location of a plurality of users;
determining a subset of the plurality of users that are located in the geographical zone;
updating the chat interface with users determined to be in the subset; and
preventing users outside of the subset from communicating with the chat interface.

17. The method of claim 10, comprising:
determining the user's location is entering or leaving a geographical zone;
generating a notification to the user; and
sending the notification to the user.

18. The method of claim 10, comprising:
storing the geographical zone for future use as global positioning satellite coordinates of the area within the boundaries of the geographical zone.

19. A non transitory computer readable medium having instructions to direct one or more processors to:
generate a map around a location of a user;
receive an input of the user defining boundaries of a geographical zone by the user interacting with the map;
generate a geographical zone based on the input of the user; and
create a chat interface associated with the geographical zone for users located within the geographical zone to send messages to the chat interface.

20. The non-transitory computer readable medium of claim 19, wherein the messages are text, emojis, video recordings, video live streams, audio recordings, audio live streams, photographs, or moving GIFs.
